(19) United States
(12) Patent Application Publication
(10) Pub. No.: US 2002/0178241 A1
(43) Pub. Date: Nov. 28, 2002

(54) Framework for a dynamic management system

(76) Inventor: Par Eriksson, Trangsund (SE)

Correspondence Address: JENKENS & GILCHRIST, 3200 Fountain Place, 1445 Ross Avenue, Dallas, TX, 75202-2799, US

(21) Appl. No.: 09/972,382

(22) Filed: Oct. 4, 2001

Related U.S. Application Data
(60) Provisional application No. 60/281,287, filed on Apr. 3, 2001.

(51) Int. Cl. G06F 15/177

(52) U.S. Cl. 709/222; 709/223

(57) ABSTRACT

A method and system for enabling a management system to learn at least one requirement of a previously unknown function. The management system includes a server which stores a list of types of devices, as well as configurations and settings for these devices. If the device attempts to initiate an unknown function, the server interrogates the device for an identification of pertinent information such as settings or configuration information. The device then sends the requested identification information to the server. After receiving the information, the server adapts to allow for effective execution of the previously unknown function. Alternatively, the server, upon determining that the function is not known, can contact an Internet server of the manufacturer of the device to request the pertinent information. In response, the server receives the requested information and adapts accordingly.

### BACKGROUND OF THE INVENTION

1. Technical Field of the Invention

The present invention relates in general to the configuration of communication devices and, in particular, to a method and system for a management system to discover at least one requirement of an unknown function in a communication device.

2. Description of Related Art

A management system is a combination of components working together to manage, for example, personal computers connected to local area networks (LANs). The management system includes servers that typically store a variety of information relevant to the system. However, this information is constantly changing due to improvements in devices that use the management system, or new devices or functions that were not known at the time the information was stored in the server. Therefore, each time new or improved devices are introduced, the server must be updated to accommodate these devices, and the devices must be configured to use specific features.

Maintaining updated information in servers accounts for a significant portion of server downtime. This process is tedious and time consuming, and can result in hours of server downtime depending on the nature of the changes made to the information within the server. Additionally, by manually loading the updated information, configuration errors may be introduced by human error.

Other updating procedure exist, although it is assumed that the system is already configured to allow full functionality of the device attempting the update. For example, a communication device may be remotely programmed from a customer activation system to effect activation. During activation, information describing the communication device's electronic serial number (ESN) is collected along with area of use information. A mobile identification number (MIN) is assigned in response to the area of use information. A remote programming session is then performed by transferring the newly assigned MIN to the communication device over a voice channel. The communication device is now activated and therefore able to transmit and receive data. SIM cards and other software located within the device may also be updated using the above-mentioned procedure. This technique, unfortunately, does not account for any functions that will not perform properly due to outdated server information.

If a user of the communication device attempts to use a function unknown to the management system, the present techniques allow the user to manually alter the settings of the device in order to use that particular function. Although this is an improvement upon waiting for the management system to be updated, the subscriber may nevertheless find this process difficult and time consuming.

Using the current methods, if a communication device supports a function not known to the management system, then the device user is unable to use that function until the device user manually alters the settings of the device, or until the server has been manually updated, which may be days or months later. For example, management systems used for management of personal computers connected to Local Area Networks (LANs) typically employ the Simple Network Management Protocol (SNMP) and can be loaded with Management Information Bases (MIBs), but such MIBs must be manually loaded into the management system.

Therefore, a system and method is needed for enabling management system to learn requirements of unknown functions and how the device needs the function to be set (e.g. the order in which the settings are needed), thereby significantly reducing the downtime needed to update the management system and simplifying the configuration procedure for new devices and applications.

### SUMMARY OF THE INVENTION

The present invention comprises a system, method, and communication device for configuring settings related to a function supported by the communication device. A communication device attempting to use a previously unknown function transmits a description of needed configuration information to the server. The server sends a response to the communication device providing the needed information, which allows for the communication device to configure the settings in accordance with the server response.

In one embodiment, the communication device comprises an electronic storage medium for storing instructions to enable the device to execute several tasks. Optionally, the communication device is enabled to receive a request from a management server for an identification of configuration information needed to allow operation of a function. The communication device, either in response to such a request or in response to some other indication that the device needs to be configured, transmits the identification of the needed configuration information to the management server. The communication device receives a response from the management server which includes the needed configuration information required to configure the communication device to allow for use of the function.

In another embodiment, settings related to a function of a communication device are configured by transmitting an identification of configuration information needed to allow operation of the function to the management server. Subsequently, a response, which includes the configuration information required to configure the communication device to allow for use of the function, is received from the management server.

In a third embodiment, a management system capable of learning at least one requirement of a previously unknown function of a communication device comprises a management server which stores a list of communication devices and configuration information pertaining to the communication devices. The server receives requests for configuration data for a previously unknown function from a particular communication device, and in response, the server transmits a request to the communication device for an identification of configuration information related to the previously unknown function. The management server then receives the identification of the configuration information pertaining to the previously unknown function. The management server adapts to enable use of the previously unknown function and updates the list of communication devices and configuration information to include the previously unknown function.

### BRIEF DESCRIPTION OF THE DRAWINGS

For a more complete understanding of the present invention, reference is made to the following detailed description taken in conjunction with the accompanying drawings wherein:

FIG. 1 is a block diagram of a management system in accordance with one embodiment of the present invention;

FIG. 2 is a flow diagram of an updating procedure of a communication device in accordance with one embodiment of the present invention;

FIG. 3 is a signaling diagram of the configuration procedure in accordance with one embodiment of the present invention;

FIG. 4 is a block diagram of an illustrative example of how a communication device accesses a WAP server in accordance with one embodiment of the present invention; and

FIG. 5 is a block diagram of an illustrative example of how a communication device accesses email via a network in accordance with one embodiment of the present invention.

### DETAILED DESCRIPTION OF THE INVENTION

In accordance with the present invention, a device management system can dynamically discover the requirements of new devices and applications using software components in the management system and in each managed device and/or application. When a user attempts to use a device or application, which can be beneficially supported by the management system, but that is previously unknown to the management system, the management system requests a list of required settings and supported parameters from the device or application. The device or application can then respond by providing a description of itself including, for example, information regarding how the device or application can be configured, which settings and parameters are required or supported, and the like.

Alternatively, the device or application can respond by providing an address, such as a URL, or other similar information identifying where a description of the device or application can be found. The management system can then retrieve the necessary information from the identified location. The management system could then use the received information to dynamically build a user interface for an operator that would manage the device or application through the management system.

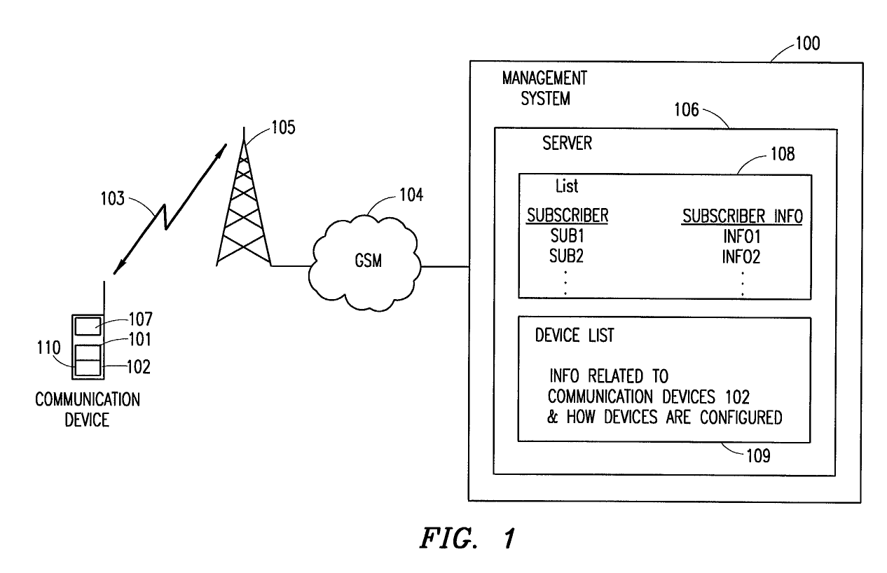

Referring now to FIG. 1, there is illustrated a block diagram of a management system 100 that can be implemented in accordance with the present invention. Although the present invention is described as communicating with the management system 100 via a wireless communication link 103 between a communication device 102 and a base station 105, a variety of other manners of communication are possible, such as SMS, Bluetooth, or an infrared link. Using such a link, the communication device 102 could contact the management system 100 via another computer included in the same LAN as the management system, through an Internet connection between the communication device 102 and the management system 100, or through a direct connection (e.g., by a cable in a small system). In one embodiment of the invention, the communication device 102 can be a mobile phone, such as a “smart” phone, having a WAP browser and e-mail capability, although the device could also be some other type of portable communication device, such as a palm top computer, an organizer, or a communicator. Such devices can communicate with the management system 100 via a GSM modem in a PCMCI or PC card.

The communication device 102 includes an electronic storage medium 101 for storing instructions and a control unit 107, such as a microprocessor, for executing the instructions. The control unit 107 regulates a transceiver 110 which transmits an indication of the needed configuration information to the management server 106. The transceiver 110 also receives a response from the management server 106 including the needed configuration information and forwards the received response to the control unit 107. In this manner, the electronic storage medium 101 and the control unit 107 collectively allow the communication device 102 to operate in accordance with the present invention.

The communication device 102 contacts the management system 100 via, for example, a Global System for Mobile Communication (GSM) network 104. It will be understood, however, that the present invention is not limited to GSM but can be integrated with any wireless communication standard capable of data communication (e.g. WCDMA, CDMA, PCS, and the like). Accordingly, while information is described in some cases as being stored on a SIM card, such information would typically be stored in the device itself in non-GSM embodiments. The management system 100 can include a plurality of interconnected servers, but this example is limited to one server 106 for easier understanding of the present invention. The server 106, which might be run, for example, by a mobile network operator, stores information about a user that is associated with the communication device 102 such as the name, phone number, and billing information of the subscriber. This information is maintained in a subscription list 108 of different subscribers and their corresponding information.

The server 106 also stores information related to some types of communication devices 102 and how the devices 102 are configured in a device list 109. However, the device list 109 might not include any information regarding certain new devices 102, or certain functions of the device 102 that are currently unknown to the server 106, such as a Wireless Application Protocol (WAP) browser or email capabilities. At this point, a user of the communication device 102 must manually configure the device 102 to allow use of the unknown function. Otherwise, the unknown function cannot be used because the server 106 is not aware of any of the requirements for the unknown functions in the device list 109 and thus cannot support the unknown function or otherwise assist in configuring the device or application.

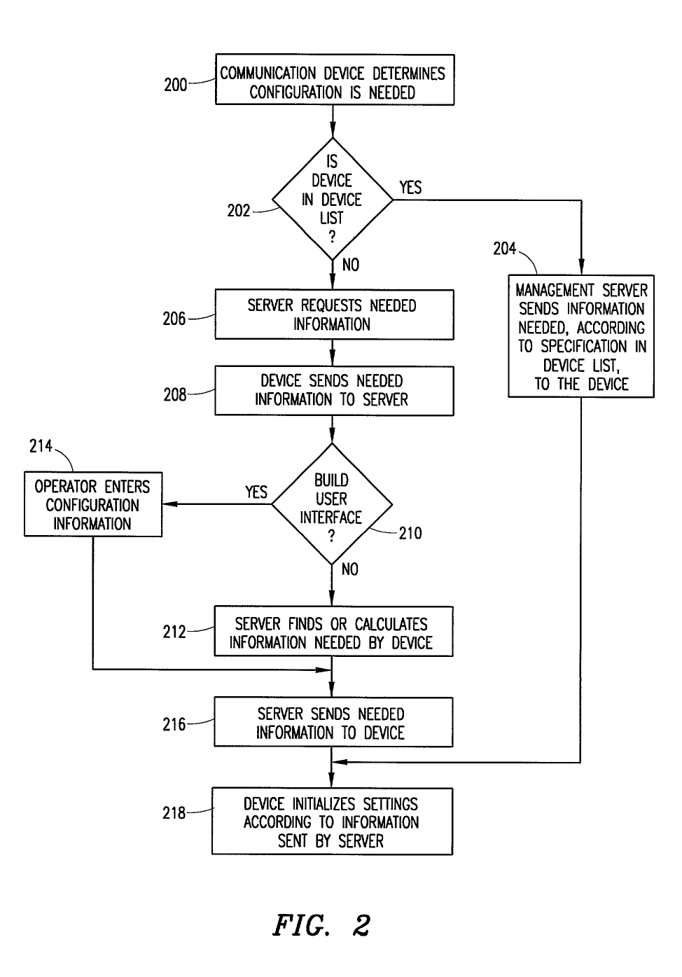

To remedy this matter, as shown in FIG. 2, it is determined either by the communication device 102, or the user of the device 102, that configuration is needed in order to use a previously unsupported or otherwise unknown function such as a WAP or e-mail functionality for the first time, in step 200. Normally, the user would not be able to use such a functionality without first performing complicated configuration procedures. One possible alternative, however, is to use the management services provided by the operator. The device 102 may, when activated or powered up, determine that a particular function must be configured before a user can activate the function. The transmitter 110 of the device 102 can send an indication or identification of the necessary configuration information immediately, without prompting from the management system 100. Alternatively, the device 102 can prompt the user that configuration is needed before the function can be utilized. In this case, the device might have a menu selection in which the user responds to a configuration request with an affirmative answer. Another option would be to start the configuration process when the user attempts to use a particular function for the first time.

The communication device 102 then connects to the management system 100 to register the device and/or application. This connection can be accomplished via SMS or by using an address, URL, or dialable number stored on a SIM card obtained upon subscribing to a particular service or included in a prepaid service card sold by the network operator. Using the connection, the communication device 102 accesses the electronic storage medium 101 to provide information to the management server 106 identifying the type and manufacturer of the device 102 (e.g. R380 and Ericsson) and/or identifying the desired service or application. In response, the server 106 determines that either the communication device 102 is not included in the device list 109, or the device 102 is in the device list 109 and has not been previously configured to use the requested application in step 202.

If the server 106 determines that the device 102 is in the device list 109, then in step 204, then the management server 106 sends the needed information back to the device 102 in accordance with the description stored in the device list 109. The following steps are then bypassed, and the device initializes settings according to the received information in step 218. However, if the device 102 is not in the device list 109, in step 206, the server 106 sends a request to the communication device 102 for the type of device and the configuration or settings information related to the device 102 or application.

In a first exemplary embodiment in step 208, the requested information is stored in the communication device 102 itself, or alternatively on a SIM card, and the electronic storage medium 101 within the communication device 102 responds by sending a description of the needed information to the server 106 or the management system 100. In an alternative embodiment, it is not necessary for the server 106 to send a request. Instead, the communication device 102 can send the identification or indication of the needed information without being prompted by the management server 106 (e.g., by sending the identification or indication along with the original identification of the desired service or application). The needed information could be the settings for the device 102 to function properly. The description identifies the device 102 or application, as well as provides information concerning how the device 102 or unknown function can be configured.

More particularly, the description identifies a function supported by the communication device 102 and how the parameters used by the function need to be configured. The function can be something not previously supported or known by the management system 100 or server 106, but by informing the management system 100, the management server 106 can be later updated with the information needed to support the function by, for example, providing GPRS settings. The information could also include information that the management system 100 might use to construct a user interface for operators to manage the communication device 102 or unknown function through the management system 100. The server 106 then determines whether or not to build a user interface in step 210. If a user interface is not built, then, in step 212, the server 106 calculates or determines the information needed by the device 102 or application. Alternatively, if an interface is built, then the operator of the management system 100 enters the necessary configuration information or other information via the user interface in step 214. In step 216, the needed information is then sent back to the device 102 from the server 106. In step 218, the device 102 configures itself in accordance with the server 106 response. After this initial configuration, the subscriber can thereafter use the function without changing any additional settings.

In a second embodiment of the present invention, as an alternative to storing the configuration information in the communication device 102, a uniform resource locator (URL) could be stored instead. The URL specifies the location of the needed information, typically a web page on the Internet. The electronic storage medium 101 included in the communication device 102, upon receiving the request for information, or in response to a user deciding to configure the device 102, transmits the URL to the management system 100. In response, the management system accesses the URL and retrieves the needed information. This embodiment, however, generally can be implemented only where there is access to the Internet.

One possible way to format the messages sent to, generated by, and/or sent by the management system 100 is to use Extensible Markup Language (XML). The management system 100 uses a Document Type Definition (DTD) to specify how the device 102 descriptions are formatted as XML documents. For instance, the descriptions that are stored in the device 102, in the application, or on a server at a corresponding URL and that are provided to the management system 100 or server 106 in response to the request at step 204 are encoded using XML. Similarly, the management server 106 can generate configuration messages as XML documents using the specified DTD, for transmission to the communication device 102.

An illustrative example of a description of a Wireless Application Protocol (WAP) function that is sent from the communication device 102 to the server 106 is as follows:

<WAP>

| | |
|---|---|
| <GW> | TP</GW> |
| <NAP> | QPN</NAP> |
| <XYZ> | Address format</XYZ> |
| </WAP> | |

where GW stands for gateway, NAP stands for Network Access Point, IP stands for an IP address, QPN stands for a phone number, and XYZ identifies or stands for the previously unsupported or otherwise unknown function. Preferably, the IP address is an actual IP address, such as “198.17.1.2”, and the phone number includes an international prefix. The unknown function could be, for example, a general packet radio service (GPRS) address to be set for the device 102 in a case where the device 102 supports GPRS but needs to be configured with a GPRS address.

The description provides a list of the information needed by the device or application and the format in which it is needed, such as the order in which the device needs the information. This formatting information is generally needed because the management server 106 might normally store and use the information in a different way. For example, the server 106 may store the gateway (GW) in the form of a URL, and the NAP could be stored as an IP address. The information could be stored in a different order, and the server 106 might also include additional information (e.g., information about bookmarks).

The server 106 receives the list of needed information and, for purposes of providing configuration information to the electronic storage medium 101 of the communication device 102, adapts itself to the format required by the communication device 102. In some cases, the management server 106 might not have the information identified in the description. For instance, because the function XYZ is previously unknown, the management server 106 likely does not know what is meant by “XYZ” or does not possess the necessary information. In such a situation, the management server 106 can contact an Internet server of the device manufacturer to find out what is meant by “XYZ”. Service personnel can later update the management server 106 with this type of information after the device manufacturer has informed the operator.

The management server 106 further finds out or calculates the information identified in the description of the unknown function. For example, in accordance with the above example, the management server 106 determines the IP address associated with the URL of the gateway and the phone number of the network access point. This information is then sent to the communication device 102 in the form of a second list in the way and order specified in the first list. Thus, the response of the server 106 could be as follows:

<WAP>

| | |
|---|---|
| <GW> | 198.17.1.2</GW> |

| | |
|---|---|
| <NAP> | +46 8 01 32 37</NAP> |
| <XYZ> | GPRS-Address</XYZ> |
| </WAP> | |

The communication device 102 configures its WAP browser in accordance with the received information, and the user can thereafter use the WAP browser without having to manually enter the settings.

In some implementations, the communication device 102 might contact the same operator for configuring the previously unknown function as is used for accessing the mobile network. Alternatively, the function might be supported by a different operator than the operator of the mobile network, in which case the information relating to how to contact the management server 106 would not be included in the SIM card but would need to be obtained in a different way.

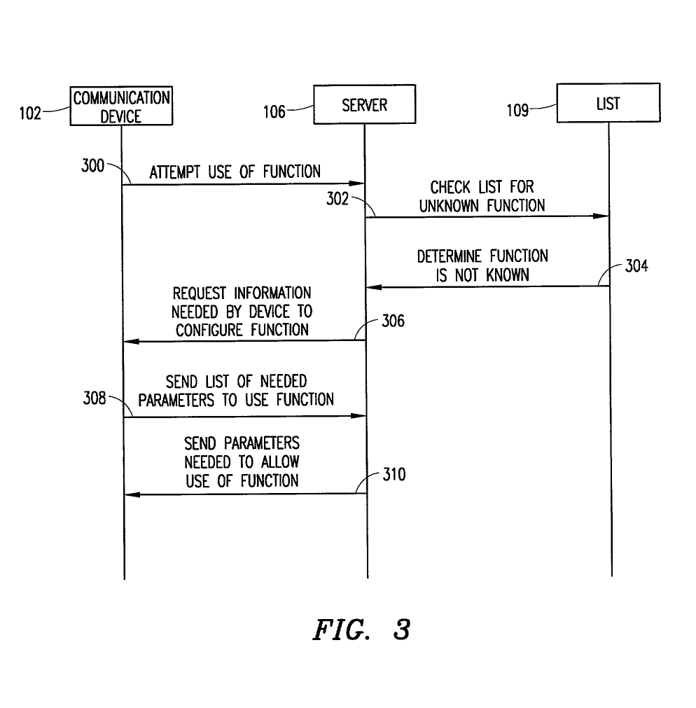

FIG. 3 represents a signaling diagram in accordance with one embodiment of the present invention. First, at step 300, the communication device 102 attempts to use a function by sending a message to the management server 106. The server 106, upon receiving a signal to use the function, at step 302 checks the device list 109 for information related to the function. At step 304, the device list 109 is scanned, and it is determined that no information exists that is related to the function. The server 106, at step 306, sends a request to the communication device 102 requesting a description of the information needed by the device 102 to configure itself. At step 308, the electronic storage medium 101 enables the communication device 102 to send a list of the parameters needed to use the function. In response, after identifying or calculating the values of the parameters, the server 106 sends the parameter values back to the communication device 102 at step 310. The communication device 102 can then configure the settings according to the parameters received at step 310. Once the settings are configured, the communication device 102 may use the function that was previously unknown at the server 106 and for which the device 102 was previously not configured.

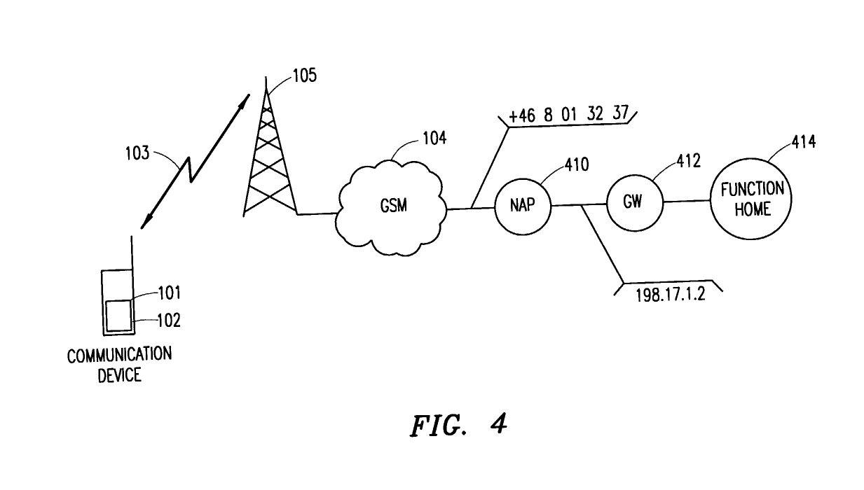

FIG. 4 illustrates an example of how the communication device 102 uses the information received from the server 106 to access a function. The communication device 102 first contacts the NAP 410 using the phone number +46 8 01 32 37. The gateway 412 is then contacted with the IP address 198.17.1.2, which allows access to a server 414, such as a WAP server, that supports the function. Once access is gained, the function of the device 102 is enabled. In addition to providing WAP settings, the same procedure could be used to provide e-mail settings for the communication device 102. In this case, the list of necessary configuration settings would include protocol information (e.g., IMAP, POPs, or a new protocol called “kalle”), incoming mail server and outgoing mail server settings, and NAP information. Furthermore, the e-mail and WAP setting information could be included in the same or separate lists.

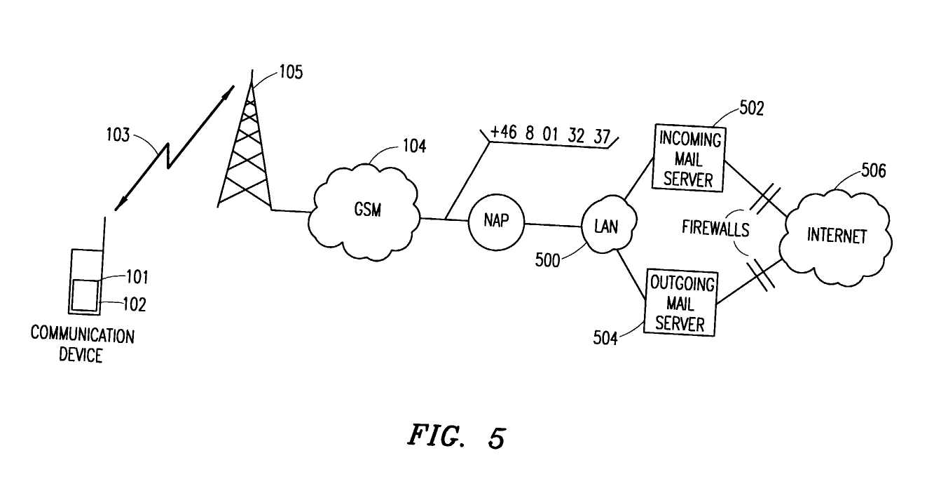

FIG. 5 is a block diagram of an illustrative example of how a communication device accesses email via a network. The communication device 102 communicates with the NAP 410 using the phone number +46 8 01 32 37. The NAP 410 then permits access to the LAN 500, which is connected to an incoming mail server 502 and an outgoing mail server 504. The incoming and outgoing mail servers 502, 504 are also connected to the Internet 506, which thereafter allows the communication device 102 to retrieve and send email. The incoming mail server 502 receives and stores incoming mail for the communication device 102. When the device 102 connects to the incoming mail server 502, the stored mail is transferred to the device 102. The outgoing mail server 504 accepts outgoing mail from the communication device 102 and forwards the mail to the Internet 506 or to internal recipients as specified by the addresses in the mail messages.

The management system 100 can be associated with either a network operator or a provider of the application in question. In either case, once the e-mail and WAP server settings in the communication device 102 have been made, the information for any new functions can be sent using e-mail or WAP as well as via SMS, a cable, or an infrared, Bluetooth, or other local wireless link.

Moreover, the invention can be used in connection with third party applications, such as bank transactions, a game, or some other program loaded into a mobile phone from a third party (i.e., a party other than the operator or the manufacturer of the phone). The application could be loaded into the phone, for instance, from the Internet via the phone's WAP browser. To use the application, however, there might be a need for certain settings to be provided by a management system 100, in which case the phone would contact the appropriate management system with a list of the necessary settings and the required format as described above. For example, the necessary settings might be indicated by “S1= . . . ” and S2= . . . ”. A server 106 in the management system 100 could then respond by providing the requested information (e.g., S1=abc; S2=qxz), which the phone could then use to be able to use the particular application. The necessary settings and their types (i.e., S1 and S2) for use of a third party application could be described and documented in a description of the application obtained by the management server 106 from a response formulated by the electronic storage medium 101 of the communication device 102 or from a web page for the application provider, in which case the communication device 102 would simply provide a link to the web page.

Although a preferred embodiment of the method and system of the present invention has been illustrated in the accompanying Drawings and described in the foregoing Detailed Description, it is understood that the invention is not limited to the embodiment disclosed, but is capable of numerous rearrangements, modifications, and substitutions without departing from the spirit of the invention as set forth and defined by the following claims.

What is claimed is:

1. A communication device operable to configure settings related to a function supported by the communication device, said communication device comprising:
an electronic storage medium storing instructions to enable the communication device to:
transmit an indication of needed configuration information to a management server; and
receive a response from said management server, said response including said needed configuration information required to configure said communication device to allow for use of said function.

2. The communication device of claim 1, wherein said electronic storage medium transmits said indication in response to a request received from said management server for said indication of said configuration information needed to allow operation of said function.

3. The communication device of claim 2, wherein the request received from the management server is in response to one of an attempt to use said function on the communication device and a setup request sent from the communication device.

4. The communication device of claim 1, wherein the indication of the needed configuration information includes an identification of a plurality of parameters and an indication of a required format for the plurality of parameters.

5. The communication device of claim 1, wherein the indication of the needed configuration information transmitted from the communication device comprises an address of a server that stores an identification of a plurality of parameters and an indication of a required format for the plurality of parameters.

6. The communication device of claim 1, wherein the function comprises at least one of a Wireless Application Protocol (WAP) functionality and an electronic mail functionality.

7. The communication device of claim 1, wherein the communication device transmits the indication of the needed configuration information and receives the response from the management server using Extensible Mark-up Language (XML).

8. The communication device of claim 1, wherein the communication device comprises a wireless device.

9. The communication device of claim 1, wherein said indication includes an identification of one of the type and manufacturer of the communication device.

10. The communication device of claim 1, wherein said communication device transmits said indication in response to one of a power up of the communication device and a user menu selection.

11. The communication device of claim 1 further comprising a control unit for reading the instructions from the electronic storage medium and executing the instructions.

12. A method for configuring settings related to a function of a communication device, said method comprising the steps of:
transmitting an identification of configuration information needed to allow operation of said function to a management server; and
receiving a response from said management server including said configuration information required to configure said communication device to allow for use of said function.

13. The method of claim 12, wherein said transmitting step is in response to a request received from said management server for said identification of configuration information needed to allow operation of said function.

14. The method of claim 12, wherein the identification of the needed configuration information includes an identification of a plurality of parameters and an indication of a format for said plurality of parameters.

15. The method of claim 12, wherein the identification of the needed configuration information includes an identification of said function and one of a type and manufacturer of the communication device.

16. The method of claim 12, wherein the identification of the needed configuration information is transmitted in response to one or a power up of the communication device, and a user menu selection on the communication device, and an attempt to use said function.

17. A management system capable of learning at least one requirement of a previously unknown function of a communication device, said management system comprising:
a management server operable to:
store a list of communication devices and configuration information pertaining to communication devices;
receive, from said communication device, an indication of configuration information pertaining to said previously unknown function;
adapt to enable use of said previously unknown function in response to the received indication of said configuration information; and
update said list of communication devices and configuration information to include said previously unknown function in response to the received indication of said configuration information.

18. The management system of claim 17, wherein said management server is further operable to:
receive a request for configuration data for said previously unknown function from a particular communication device; and
transmit a request to said communication device for said indication of configuration information related to said previously unknown function, wherein said indication of said configuration information is received in response to said request.

19. The management system of claim 18, wherein said communication device transmits said indication of said configuration information to said management server in response to said request.

20. The management system of claim 17, wherein said indication of configuration information comprises an address of a server associated with the previously unknown function.

21. The management system of claim 20, wherein said management server further operates to retrieve data relating to the previously unknown function from the server at said address.

22. The management system of claim 21, wherein said data comprises said indication of said configuration information.

23. The management system of claim 17, wherein the management server determines a value of at least one parameter identified in said indication of said configuration information.

24. The management system of claim 23, wherein the management server transmits the value of the at least one parameter to the communication device.

25. The management system of claim 23, wherein the value of the at least one parameter is transmitted in a Extensible Mark-up Language (XML).

26. The management system of claim 25, wherein the XML message is formatted in accordance with a format indicated by the indication of the configuration information.

27. A method for enabling a management system to learn at least one requirement of an unknown function, said method comprising:
determining whether at least one of a device and a function identified in a message received by the management system is unknown;
requesting information relating to the at least one of the device and the function, after determining that at least one of the device and the function is unknown;
receiving said requested information from said device;
determining a set of configuration parameters necessary to use the at least one of the unknown function and the unknown device in response to said received information; and
sending the set of configuration parameters to said device.

28. The method of claim 27 further comprising the step of initializing at least one setting of said device according to the set of configuration parameters.

29. The method of claim 27 further comprising the steps of:
building a user interface, in response to the received information, for entry of the set of configuration parameters; and
receiving an entry of the determined set of configuration parameters from an operator using said user interface.

30. A control unit for configuring settings related to a
function supported by a communication device, said control unit operable to:
control a transceiver to transmit an indication of needed configuration information to a management server; and
receive via said transceiver a response from said management server, said response including the needed configuration information required to configure the communication device to allow for use of said function.
